(19) United States
(12) Patent Application Publication
(10) Pub. No.: US 2004/0050608 A1
(43) Pub. Date: Mar. 18, 2004

(54) Vehicle safety escape apparatus

(76) Inventor: Lonny MacDougall, Phoenix, AZ (US)

Correspondence Address: Steven Thrasher, 391 Sandhill Dr., Richardson, TX, 75080, US

(21) Appl. No.: 10/244,239

(22) Filed: Sep. 16, 2002

(51) Int. Cl. B60R 21/00

(52) U.S. Cl. 180/271

(57) ABSTRACT

The invention provides vehicle window-shattering systems and apparatuses. One embodiment of the apparatus includes a base having an opening large enough to accommodate a seat belt, and a tip coupled to the base.

### RELATED APPLICATIONS

The present Non-Provisional Patent Application relates to co-filed and co-pending U.S. patent application Ser. No. ______ entitled BODYMOUNTABLE VEHICLE SAFETY ESCAPE APPARATUS by Souther, et al., filed on Sep. 13, 2002.

### FIELD OF THE INVENTION

The invention relates to safety systems and devices for vehicles, and, more particularly, the invention relates to safety systems and apparatuses for shattering glass to facilitate escape from a vehicle.

Problem Statement

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Statement of a Problem Addressed by This Invention is to be construed as prior art.

Discussion

Persons may become trapped in a vehicle due to a wide variety of circumstances. During flood conditions, sometimes a person will try to drive through water in a flooded street or depression without realizing how deep the water is or how fast a current is moving. Sometimes, due to poor driving or to poor road conditions, a person will drive a car into a body of water, such as a reservoir or a lake, thereby trapping the occupants of the vehicle inside. In yet other circumstances a vehicle occupant may be trapped inside a car during a wreck. Occasionally, vehicles in a wreck catch on fire and burn any occupants who are trapped inside. Whether due to fire, flood, or other trapping, vehicle occupants need a means for escape in the event they are trapped inside and face potential danger.

Unfortunately, doors are frequently jammed shut in emergency situations such as fires, floods, or wrecks. Therefore, an occupant of the vehicle cannot simply open a door and escape. In addition, since systems are often inoperative in such emergency situations, power windows cannot be opened. Furthermore, even if power systems do work or even if mechanical systems are operable, the windows are also frequently jammed shut or do not completely/sufficiently open.

When the doors and windows are both jammed in an emergency situation, it is necessary to shatter a window so that the occupants can escape. However, vehicle windows are constructed to be at least minimally shatter resistant. Thus, it is desirous to provide a vehicle window-shattering tool that is effective, easily reached, and easily handled in an emergency. The present invention provides such systems and devices.

Selected Overview of Selected Embodiments

The invention provides technical advantages as vehicle window-shattering systems and apparatuses. One window-shattering system generally includes a base system that couples to a seat belt, and an impact system that is able to shatter a vehicle window. One embodiment of the apparatus includes a base having an opening large enough to accommodate a seat belt web, and a tip coupled to the base. Preferably, the tip is sufficiently hard and shaped to enable the vehicle window shattering apparatus to shatter a pane of glass. Accordingly, the invention provides an accessible and effective window-shattering means that provides a vehicle occupant means to escape a vehicle in the event of an emergency.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention and it should be understood that the invention is not limited by the detailed description. Accordingly, the invention should be read as being limited only by the claims.

### BRIEF DESCRIPTION OF THE DRAWINGS

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings, in which:

FIG. 1 illustrates one embodiment of the invention that is slidably-mounted to a seat belt web;

FIGS. 2a-2c show vehicle window-shattering apparatuses that are capable of being retroactively securely attached to an seat belt that is already installed in a vehicle; and

FIG. 3 illustrates the invention having a clasping assembly that enables the invention to be securely retrofitted to a web of a seatbelt;

FIGS. 4a-4b are views of a window-shattering apparatus that is installable via a snap-hinge; and

FIG. 5 provides one view of an alternative embodiment that incorporates a blade for slicing a seatbelt.

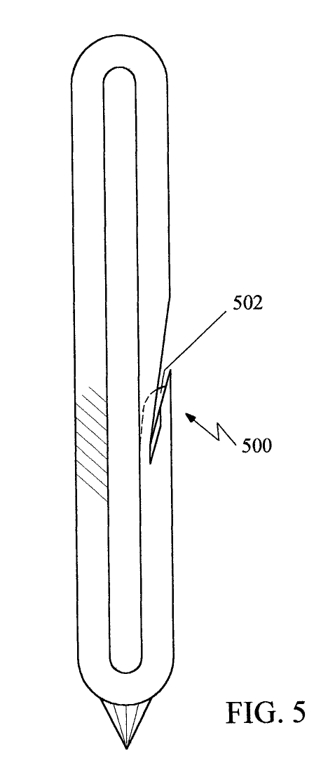

### EXEMPLARY EMBODIMENT OF A BEST MODE

Introduction

The invention provides vehicle window-shattering systems and apparatuses. One window-shattering system generally includes a base system that couples to a seat belt, and an impact system that is able to shatter a vehicle window. One embodiment of the apparatus includes a base having an opening large enough to accommodate a seat belt, and a tip coupled to the base, the tip being of sufficient hardness and shape to enable the shattering of a pane of vehicle glass. Accordingly, the invention provides an easily-accessible and effective window-shattering means that provides a vehicle occupant means to escape a vehicle in the event of an emergency.

Interpretation Considerations

When reading this section (AN EXEMPLARY EMBODIMENT OF A BEST MODE, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment. Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in 112, paragraph 6 of 35 U.S.C., unless used as “means for functioning-” or “step” for -functioning-“ in the claims section.

Exemplary Devices and Systems

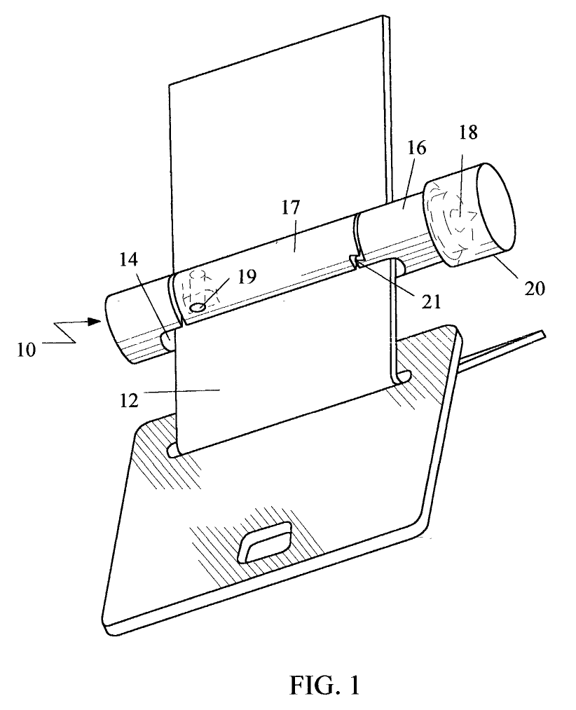

In one embodiment, the invention generally comprises a base that includes an opening, and a tip coupled to the base. FIG. 1 illustrates one embodiment of the invention that is mounted (yet slidably positionable) to a web 12 of a seat belt (or shoulder harness). The vehicle window-shattering apparatus (the apparatus) 10 has a base 16 that is generally cylindrical and elongated enough to accommodate the web 12 of a seat belt. In addition, the apparatus 10 includes a tip 18 that is enabled (via shape and hardness) to shatter a pane of a vehicle window (not shown). In one embodiment, the tip is generally a point, however, it should be understood that many shapes capable of shattering a window are readily apparent to one of ordinary skill in the art, and any shape capable of shattering a vehicle window is within the scope of the invention. In addition, the tip is made of material that is harder than a pane of glass, and is preferably a carbide-based material, such as carbide-steel. However, many materials capable of shattering a window are readily apparent to one of ordinary skill in the art, and any material capable of shattering a vehicle window is also within the scope of the invention.

The base 16 includes an opening 14 configured to attach to the web 12 of a seatbelt. In general, the opening 14 is slightly larger than the web 12. Accordingly, the base 16 is securably coupled to the web 12, meaning that the base 16 will not slide up or down the web 12 absent the application of some force—such as a user pulling the apparatus 10 up or down the web 12. Of course, the base 16 may also be freely slidable along the web 12. Accordingly, the apparatus 10 can slide from a position where it is disposed against a tongue 13 to a position proximate to the ceiling of the vehicle (not shown) sot that the apparatus 10 may be secured in a position where it will not interfere with a vehicle occupant.

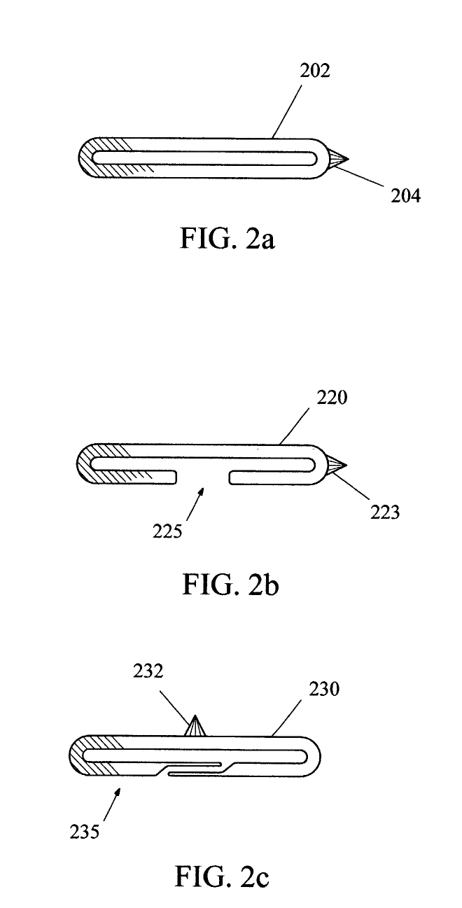

There are many alternative embodiments for the base 16. It can be made of metal, or any durable plastic/rubber material. In one embodiment, the base 16 may be a closed ring (having the appearance of an elongated “O”) such as the apparatus 202 of FIG. 2a having tip 204. To attach a closed ring to a web 12, the base 16 must be slid over the web 12 before the seat belt is completely attached in the car. Alternatively, the base 16 may be configured to attach to a web 12 of a seatbelt that is already installed in a vehicle to create a “retrofit” embodiment. For example, the base may include an open portion, so that the base has a generally “C” shape such as the apparatus 220 having an opening 225 as shown in FIG. 2b having tip 223. Preferably, the base having the C shape surrounds the opening across at least 220 angular degrees. In another retrofit embodiment, the base 16 operates similar to a carabineer. Accordingly, a pivotable portion, such as a hinge 19, is provided so that a swivel 17 can open and close to enable the base to be placed about the web 12. Preferably, the pivotable portion 19 enables the swivel 17 to securably clasp the web 12 in a static position.

Preferably, the swivel 17 provides a clasp 21 in order to help hold the swivel 17 in a closed position. Optionally, a sleeve (not shown) can be slidable arranged over the swivel 17 as is known in the art of carabineers, so that the sleeve slides from a central position (which allows for opening and closing of the swivel 17) to cover position about the clasp 21 where the swivel 17 may be held in a closed position.

FIGS. 2a-2c provide optional side profiles of alternative embodiments of the invention. Preferably, the tip 18 is provided on either the first end or the second end. However, the location of the tip is unimportant to the invention as the invention could have any number of tips in any location chosen by a manufacturer. In addition, it should be understood that the invention is not limited by the side profile chosen. Thus, a side profile of an oval apparatus 210 as in FIG. 2a, or a side profile resembling the letter “C” is provided by a C apparatus 220 where an apparatus may be retrofitted onto a web 12 of a seatbelt by threading the web 12 through the opening 225 of the C. FIG. 2c illustrates a side profile of a belt-clip apparatus 230 having a paper-clip type attaching means 235, and incorporates a tip 232.

Top profiles (looking at the invention head-on at the tip 18 in FIG. 1) may also vary. For example, a top profile for the apparatus 10 of FIG. 1 is generally cylindrical. However, it is understood that the invention is not limited to a particular top profile. Thus, a substantially planar top profile is used in one embodiment to increase the surface area of the base that is exposed to the web 12 of the seatbelt (when the planar surface is proximate to the web 12).

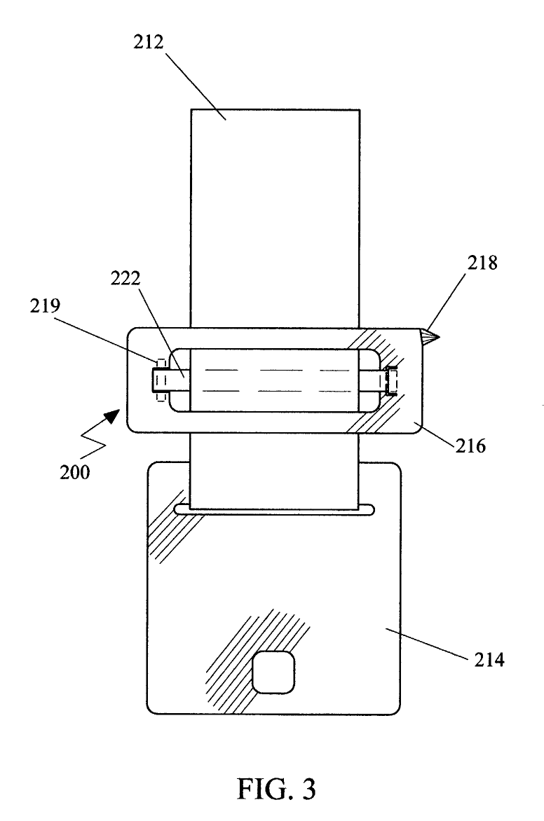

Yet additional alternative embodiments of the base are available, such as a weave-enabled embodiment 200 with base 216 that comprises three generally parallel portions illustrated in FIG. 3. The middle portion 222 of the three parallel portions is either removable, or hinged via a hinge-pin that is affixed to a base 216 and passes through the middle portion 222. Thus, the base 216 can be mounted on an existing web 212 of a seat belt by setting the base 216 against the web 212 of the seat belt (without the middle portion 222 fixed into the base). Then, by placing the middle portion 222 into a lock position in the base 200 (via hinging and locking) while the web 212 of the seatbelt is “weaved” within the base as shown in FIG. 3, one statically fixes the base to the web 212 of the seatbelt. Alternatively, in a second embodiment (not shown), if the middle portion 222 is rigidly mounted, the web 212 of the seatbelt may be weaved through alternative gaps between the generally parallel portions. Of course, in yet additional alternative embodiments, the base 216 may comprise more than three parallel portions. In addition, a tip 218 may be incorporated in any effective location on the base 216.

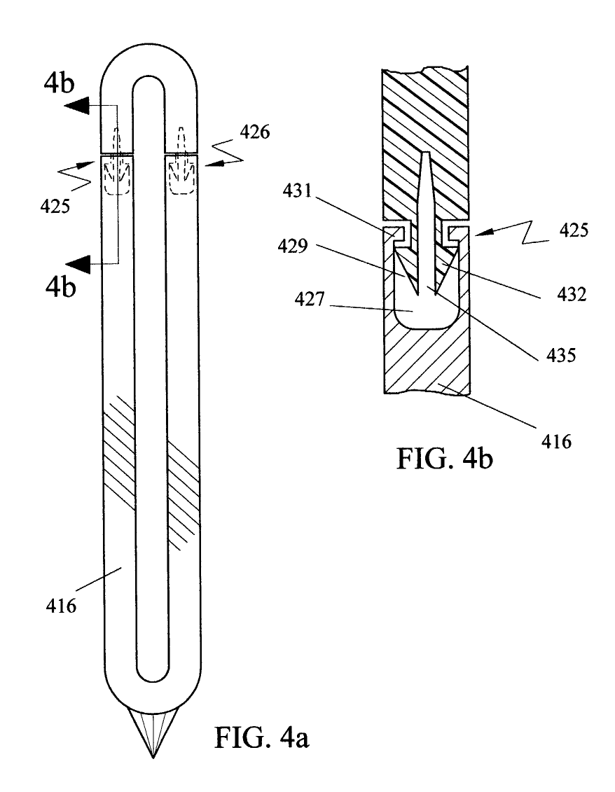

FIGS. 4a and 4b illustrate still another alternative embodiment of the invention having a clasping assembly 425 that enables the invention to be securely retrofitted to a web of a seatbelt. The base 416 comprises a first clasp assembly 425, and may include a second clasp assembly 426. Each clasp assembly 425, 426 includes a male-member clasp-tip 429 that fits within a female-member clasp-socket 427. The clasp-tip 429 comprises at least two oppositely disposed inclined-plane members 432 separated by a gap 435. The inclined-plane member 432 may be squeezed closer to each other across the gap 435, thereby decreasing the distance separating the inclined-plane members 432, and allowing the inclined plane members 432 to fit within a flange 431 in the clasp-socket 427. The flange 431 at the opening of the clasp-socket 427 is sized so that the clasp-tip 429 can enter the socket 427, but cannot be easily withdrawn. Accordingly, to create a unified base 416, the inclined-plane members 432 of the clasp-tip 429 are compressed together and inserted through the flange 431 and into the clasp-socket 427.

Referring briefly to FIGS. 1-4, one notes that a tip may be located at any position on a base. However, the tip is preferably in a position that allows a vehicle occupant easy access to impact a window to achieve window shattering or dicing (meaning that the generally sound and uniformly transparent state of the window is altered to a generally fractured state that enables a window to be easily (if only partially) removed from an automobile window seal). In addition, although only one tip is illustrated in each illustrated embodiment of the invention, it is appreciated that more than one tip may be provided on any base.

Furthermore, it is readily apparent to one of ordinary skill in the art mechanisms may be employed to mechanically hide a tip in a base, and then expose the tip for use. For example, it is known in the art to use a spring system to allow a tip to be stored out of view, and then to expose the tip upon activating of the spring system so that a window may be diced. In addition, telescoping tip systems are also adaptable to the invention.

Referring again to FIG. 1, the apparatus 10 may optionally provide a cap 20 for coving the tip 18. By providing a cap 20 that covers the tip 18, the tip will not inadvertently injure an occupant or their clothing, or damage property within the vehicle. In a preferred embodiment, the cap 20 is held to the base 16 via friction, however, a screw top closure, or any other suitable mechanism can provide equivalent functionality. In any event, it is preferable that the cap 20 be retained to the base 16 in so that it can be easily and quickly removed (in the event of an emergency). Accordingly, the cap 20 is preferably made of transparent material so that a passenger not familiar with the apparatus 10 may quickly understand and appreciate the purpose of the tip 18.

Furthermore, it is understood that readily identifiable bases may make the invention more useful. For example, a base may be a bright neon color, may include lights and light emitting diodes (LEDs), or may provide a point-source identifiable audible sound to help a user locate the apparatus in the event of an emergency. It is understood that various readily identifiable means exist and will be developed for making bases more readily identifiable in the event of an emergency, and that these means are incorporated in the invention without departing from the scope of the invention.

Likewise, it is understood that means for cutting a seatbelt may also be desired in the invention, and may be incorporated in the invention. For example, a self-propelled cutting means or an attachment release means may be incorporated in the invention so that the seatbelt will release at about the same time that a window is diced.

Though the invention has been described with respect to a specific preferred embodiment, many variations and modifications will become apparent to those skilled in the art upon reading the present application. The appended claims are to be interpreted as broadly as possible in view of the prior art to include all such variations and modifications.

I claim:

1. A vehicle window shattering apparatus (the apparatus), comprising:
a base, the base including an opening configured to accommodate a web of a seat belt (the web); and
a tip coupled to the base.

2. The vehicle escape safety apparatus of claim 1, wherein the base at least partially encircles the web.

3. The vehicle escape safety apparatus of claim 1, wherein the base completely encircles the web.

4. The base of the vehicle escape safety apparatus of claim 1 further comprising a pivotable portion pivotally connected to the base via a hinge so that the -swivel opens and closes to enable the base to be placed about the web and removed from the web.

5. The vehicle escape safety apparatus of claim 1 wherein the swivel closes about the web tightly enough to statically secure the apparatus to the web.

6. The vehicle escape safety apparatus of claim 1, wherein the base is generally C-shaped.

7. The vehicle escape safety apparatus of claim 1, wherein the base includes a clasp for accepting a swivel.

8. The vehicle escape safety apparatus of claim 1, wherein the tip is made of a material that is harder than a pane of vehicle glass.

9. The vehicle escape safety apparatus of claim 1, wherein the tip is made of a carbide-based metal.

10. The vehicle escape safety apparatus of claim 1, wherein the base is generally cylindrically shaped, and wherein the tip is coupled to a first end.

11. The vehicle escape safety apparatus of claim 1, wherein the base has substantially planar surface proximate to the web.

12. The vehicle escape safety apparatus of claim 11, wherein the tip is coupled to the substantially planar surface.

13. The vehicle escape safety apparatus of claim 1, wherein the base comprises three generally parallel portions, the middle of the three parallel portions being removable from and attachable to the base so that the base can be mounted on an existing web.

14. The vehicle escape safety apparatus of claim 1, further comprising a tip cover that is adapted to attach to the base in a manner that also covers the tip, the tip cover for simultaneously protecting the tip from damage and for protecting items in a vehicle interior from the tip.

15. A vehicle escape safety system, comprising:
a base system adapted to attach to a web of a seat belt; and
an impact system coupled to the base system, the impact system for concentrating a force on a pane of vehicle glass in order to shatter the pane of vehicle glass.

16. The vehicle escape safety apparatus of claim 15, further comprising an impact system cover that is attachable to the base system such that the impact system is protectively secured underneath the impact system cover.

17. A vehicle escape safety apparatus, comprising:
a base, the base comprising an opening configured to accommodate a web of a seat belt (the web);
the base further comprising a clasping assembly; and
a tip coupled to the base.

18. The apparatus of claim 17 wherein the clasping assembly comprises a clasp tip, and a clasp flange.

19. A vehicle escape safety apparatus, comprising:
a base comprising an opening large enough to accommodate a web of a seat belt so that the base can be mounted to the web, yet securably slide up and down the length of the web, the opening being surrounded by the base across at least 220 angular degrees; and
a tip coupled to the base.
